(19) United States
(12) Patent Application Publication
(10) Pub. No.: US 2010/0115707 A1
(43) Pub. Date: May 13, 2010

(54) SHADING COMPOSITION

(76) Inventors: Stephen Norman Batchelor, Wirral (GB); Jayne Michelle Bird, Wirral (GB); Sarah Dixon, Wirral (GB); Sue Joyce, Bebington, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/524,165

(22) PCT Filed: Jan. 18, 2008
(86) PCT No.: PCT/EP2008/050567

§ 371 Date: Jan. 14, 2010

(30) Foreign Application Priority Data
Jan. 26, 2007 (EP) 07101272.8

(51) Int. Cl. C11D 3/40

(52) U.S. Cl. 8/137; 510/276

(57) ABSTRACT

The present invention concerns the use of pigment and dye combinations for enhanced whiteness of fabrics during laundering.

### FIELD OF INVENTION

The present invention relates to the delivery of pigments and dyes to fabrics.

### BACKGROUND OF THE INVENTION

White clothes are popular among consumers. They are typically made from a variety of fabrics, 100% cotton, polyester-cotton blends (polycotton), 100% polyester, nylon and blends of these fabrics with elastane. On repeated washing and wearing cycles the garments loose whiteness. Methods to maintain whiteness of all garments types made from all fabric types from washing products are desired by consumers.

Shading dyes may be used to maintain and re-invigorate whiteness. Direct and acid, blue and violet dyes show particular utility on cotton garments. Solvent and disperse dyes give benefits on polyester, nylon and elastane containing garments.

In typical washes garments created from 100% cotton, polyester-cotton mixes and 100% polyester are washed together. When acid or direct dyes are used in the washing product to give shading benefits to the 100% cotton garment, the benefits on the polyester-cotton mix garment is lower due to the lower level of cotton. This cannot be compensated for by a higher dye level, as then the 100% cotton garments will become over shaded and appear blue/violet to the eye. Similarly for the solvent and disperse dye for polyester. In this case the situation is worse as these dyes show relatively low deposition onto woven polyester-cotton fabrics compared to nylon-elastane fabrics. Woven polyester-cotton is an important fabric for work and school shirts.

Thus there is a need for a shading system that provides maximum shading whiteness benefits over a range of fabrics, for example 100% cotton and cotton-polyester, most preferably 100% cotton and cotton-polyester, and 100% polyester.

WO2006/032327 discloses that certain organic shading dyes, selected from direct dyes, solvent and disperse dyes, acid dyes and hydrolysed reactive may be used to shade garments.

US20050288207 and WO2005/003274 discloses that basic dyes may be used to shade garments. WO2006/055787 discloses that dye conjugates may be used to shade garments to give enhanced whiteness. These dyes give effective deposition to certain fibre types, for example direct dyes deposit to cotton fibres very effectively but not to polyester or elastane fibres.

In the art Pigment Violet 23 has been used to colour granule detergent products as disclosed in U.S. Pat. Nos. 3,931,037 and 5,529,710. There is no disclosure that laundry products containing organic pigments enhance the whiteness of fabrics washed with them.

### SUMMARY OF INVENTION

One would expect that a white garment washed in a detergent product that contained a combination of organic pigment with a shading dye would have the same whiteness as the analogous product containing shading dye alone. This is not the case; garments washed in products containing an organic pigment and dye combination have greater whiteness than the product with dye alone.

Furthermore a benefit is provided to both synthetic and cotton fabrics; surprisingly the effective is greatest in the widely used polycotton fabrics, where shading dyes typically show low effects.

We have found that the laundry compositions of the present invention provide shading whiteness benefits over a range of fabrics. The laundry compositions comprise mixtures of blue and violet organic pigments with direct, acid, reactive dyes, dye conjugates, and disperse and solvent dyes.

In one aspect the present invention provides a laundry detergent composition comprising:

(a) from 2 to 90% of a surfactant;
(b) from 0.0001 to 0.5% of a blue or a violet organic pigment, preferably 0.002 to 0.02%; and,
(c) at least 0.0001 to 0.05% of one organic dye selected from:
blue or violet direct dyes; blue or violet hydrophobic dyes; blue or violet reactive dye; blue or violet basic dye; blue or violet dye conjugate; and,
acid dye selected from: (i) azine dyes, wherein the dye is of the following core structure:

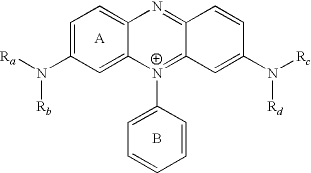

wherein Rₐ, R_{b}, R_{c} and R_{d} are selected from: H, an branched or linear C1 to C7-alkyl chain, benzyl a phenyl, and a naphthyl;
the dye is substituted with at least one SO₃⁻ or —COO⁻ group;
the B ring does not carry a negatively charged group or salt thereof;
and the A ring may further substituted to form a naphthyl; the dye is optionally substituted by groups selected from: amine, methyl, ethyl, hydroxyl, methoxy, ethoxy, phenoxy, Cl, Br, I, F, and NO₂ and,
(ii) acid violet 17, acid black 1, acid red 51, acid red 17 and acid blue 29.

In another aspect the present invention provides A domestic method of treating a textile, the method comprising the steps of:
(i) treating a textile with an aqueous solution of the laundry detergent composition, the aqueous solution comprising from 1 ppb to 5 ppm of the pigment, and from 1 ppb to 1 ppm of at least one other dye selected from: hydrophobic dyes, acid dyes and direct dyes; and, from 0.2 g/L to 3 g/L of a surfactant; and,
(ii) rinsing and drying the textile.

Preferably, pigment is present in the range from 10 ppb to 200 ppb. Preferably, when a direct dye is present it is present in the range from 2 ppb to 40 ppb. Preferably, when an acid dye is present it is present in the range from 10 ppb to 200 ppb. Preferably, when a hydrophobic dye is present it is present in the range from 10 ppb to 200 ppb.

Preferably the method is conducted where the aqueous solution is 10 to 30° C.

The pH of the aqueous solution is in the range from 2 to 12. Preferably the pH of the aqueous solution is in the range from 7 to 11. The laundry treatment composition is preferably such that when a unit dose is added to a determined volume of an aqueous environment such provides.

### DETAILED DESCRIPTION OF THE INVENTION

Pigments are coloured particles preferably of 0.02 to 10 micron size, which are practically insoluble in aqueous medium that contain surfactants. The particle size is measured by selective sieving. The size is preferred in order to reduce agglomeration of the pigment in solution and to provide efficient deposition. Preferred pigments are blue or violet. By practically insoluble we mean having a water solubility of less than 500 ppt, preferably 10 ppt at 20° C. with a 10 wt % surfactant solution.

Organic pigments are described in ‘Industrial Organic Pigments’, Wiley VCH 2004 by W. Herbst and K. Hunger.

Dyes are coloured organic molecules which are soluble in aqueous media that contain surfactants. Dyes are described in ‘Industrial Dyes’, Wiley VCH 2002, K. Hunger (editor).

Dyes and pigments are listed in the Color Index International published by Society of Dyers and Colourists and the American Association of Textile Chemists and Colorists.

Preferred pigments are pigment blue 1, 1:2, 1:3, 2, 2:1, 2:2, 3, 4, 5, 7, 9, 10, 10:1, 11, 12, 13, 14, 15, 15:1, 15:2, 15:3, 15:4, 15:6, 16, 18, 19, 20, 21, 22, 23, 25, 26, 27, 28, 29, 30, 31, 32, 34, 35, 36, 56, 57, 58, 59, 60, 61, 61:1, 62, 63, 64, 65, 66, 67, 69, 71, 72, 73, 74, 75, 79, 80, 83 and pigment violet 1, 1:1, 1:2, 2, 3, 3:1, 3:3, 3:4, 5, 5:1, 7:1, 8, 9, 11, 12, 13, 14, 15, 16, 18, 19, 23, 25, 27, 28, 29, 31, 32, 35, 37, 39, 41, 42, 43, 44, 45, 47, 48, 50, 54, 55 and 56

More Preferred organic pigments are pigment violet 1, 1:1, 1:2, 2, 3, 5:1, 13, 23, 25, 27, 31, 37, 39, 42, 44, 50 and Pigment blue 1, 2, 9, 10, 14, 18, 19, 24:1, 25, 56, 60, 61, 62, 66, 75, 79 and 80.

More preferred pigments are pigment violet 3, 13, 23, 27, 37, 39, pigment blue 14, 25, 66 and 75.

The most preferred is pigment violet 23.

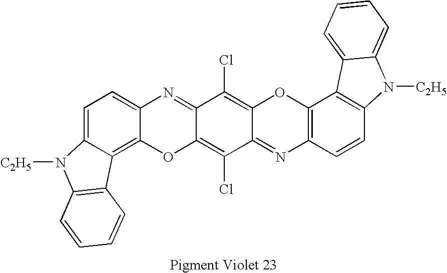

Preferably the pigment is present at 0.002 to 0.02 wt % of the formulation.

### Direct Dyes

Direct violet and direct blue dyes are preferred. Preferably the dye are bis-azo or tris-azo dyes. The carcinogenic benzidene based dyes are not preferred.

Bis-azo copper containing dyes such as direct violet 66 may be used.

Most preferably the direct dye is a direct violet of the following structures:

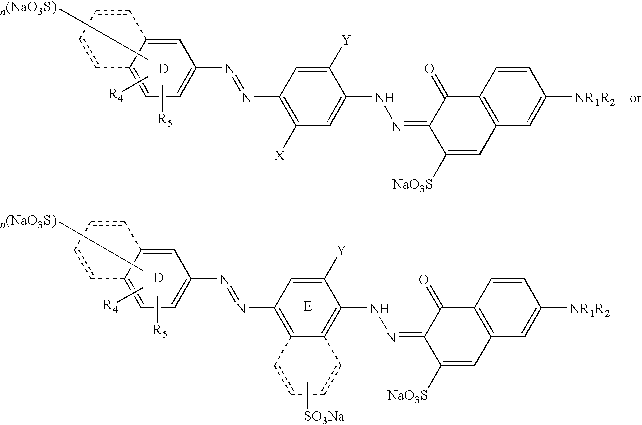

wherein:
ring D and E may be independently naphthyl or phenyl as shown;
R₁ is selected from: hydrogen and C1-C4-alkyl, preferably hydrogen;
R₂ is selected from: hydrogen, C1-C4-alkyl, substituted or unsubstituted phenyl and substituted or unsubstituted naphthyl, preferably phenyl;
R₃ and R₄ are independently selected from: hydrogen and C1-C4-alkyl, preferably hydrogen or methyl;
X and Y are independently selected from: hydrogen, C1-C4-alkyl and C1-C4-alkoxy; preferably the dye has X=methyl; and, Y=methoxy and n is 0, 1 or 2, preferably 1 or 2.

Preferred dyes are direct violet 7, direct violet 9, direct violet 11, direct violet 26, direct violet 31, direct violet 35, direct violet 40, direct violet 41, direct violet 51, and direct violet 99.

Preferably the direct dye is present at 0.0002 wt % to 0.0010 wt % of the formulation.

In another embodiment the direct dye may be covalently linked to a photobleach, for example as described in WO2006/024612.

### Acid Dyes

Cotton substantive acid dyes give benefits to cotton containing garments. Preferred dyes and mixes of dyes are blue or violet. Preferred acid dyes are:

(i) azine dyes, wherein the dye is of the following core structure:

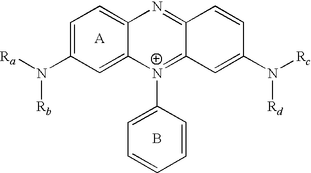

wherein Rₐ, R_{b}, R_{c} and R_{d} are selected from: H, an branched or linear C1 to C7-alkyl chain, benzyl a phenyl, and a naphthyl;
the dye is substituted with at least one SO₃⁻ or —COO⁻ group;
the B ring does not carry a negatively charged group or salt thereof;
and the A ring may further substituted to form a naphthyl;
the dye is optionally substituted by groups selected from: amine, methyl, ethyl, hydroxyl, methoxy, ethoxy, phenoxy, Cl, Br, I, F, and NO₂.

Preferred azine dyes are: acid blue 98, acid violet 50, and acid blue 59, more preferably acid violet 50 and acid blue 98.

Most preferably the azine dye is acid blue 98.

Other preferred non-azine acid dyes are acid violet 17, acid black 1, acid red 51, acid red 17 and acid blue 29.

Preferably the acid dye is present at 0.001 wt % to 0.006 wt % of the formulation.

### Hydrophobic Dyes

The composition may comprise one or more hydrophobic dyes selected from benzodifuranes, methine, triphenylmethanes, napthalimides, pyrazole, napthoquinone, anthraquinone and mono-azo or di-azo dye chromophores. Hydrophobic dyes are dyes which do not contain any charged water solubilising group. Hydrophobic dyes may be selected from the groups of disperse and solvent dyes. Blue and violet anthraquinone and mono-azo dye are preferred.

Preferred dyes include solvent violet 13, disperse violet 27 disperse violet 26, disperse violet 28, disperse violet 63 and disperse violet 77.

Preferably the hydrophobic dye is present at 0.0005 wt % to 0.004 wt % of the formulation.

### Basic Dyes

Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International.

Preferred examples include triarylmethane basic dyes, methane basic dye, anthraquinone basic dyes, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141.

### Reactive Dyes

Reactive dyes are dyes which contain an organic group capable of reacting with cellulose and linking the dye to cellulose with a covalent bond. They deposit onto cotton. Preferably the reactive group is hydrolysed or reactive group of the dyes has been reacted with an organic species such as a polymer, so as to the link the dye to this species. Dyes may be selected from the reactive violet and reactive blue dyes listed in the Colour Index International.

Preferred examples include reactive blue 19, reactive blue 163, reactive blue 182 and reactive blue, reactive blue 96.

### Dye Conjugates

Dye conjugates are formed by binding direct, acid or basic dyes to polymers or particles via physical forces.

Dependent on the choice of polymer or particle they deposit on cotton or synthetics. A description is given in WO2006/055787. They are not preferred.

Preferably the composition contains a pigment and a direct or acid dye, more preferably a pigment, direct or acid dye and hydrophobic dye, most preferably a pigment, direct dye, hydrophobic dye and acid dye.

### Inclusion

It is preferred if products are solid, granular or viscous liquids, most preferably solid or granular. In granular composition the dyes and pigments may be added to the slurry that is to be spray dried. Preferably they are added via granules post-dosed into the powder that contains all the pigments and dyes.

For ease of processing to provide the formulations it is preferred if the pigment is delivered as an aqueous dispersion containing surfactant and a polylol such as a glycol.

### Surfactant

The composition comprises between 2 to 90 wt % of a surfactant, most preferably 10 to 30 wt %. In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆ to C₂₂ alkyl phenol-ethylene oxide condensates, generally 5 to 25 EO, i.e. 5 to 25 units of ethylene oxide per molecule, and the condensation products of aliphatic C₈ to C₁₉ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈ to C₁₉ alcohols, produced for example from tallow or coconut oil, sodium and potassium alkyl C₉ to C₂₀ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁ to C₁₅ alkyl benzene sulphonates and sodium C₁₂ to C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆ to C₁₈ primary alcohol sulphate together with a C₁₂ to C₁₅ primary alcohol 3 to 7 EO ethoxylate.

The nonionic detergent is preferably present in amounts greater than 10%, e.g. 25 to 90 wt % of the surfactant system. Anionic surfactants can be present for example in amounts in the range from about 5% to about 40 wt % of the surfactant system.

In another aspect which is also preferred the surfactant may be a cationic such that the formulation is a fabric conditioner.

### Fabric Conditioner

Cationic softening material is preferably a quaternary ammonium fabric softening material.

The quaternary ammonium fabric softening material compound has two C12-28 alkyl or alkenyl groups connected to the nitrogen head group, preferably via at least one ester link. It is more preferred if the quaternary ammonium material has two ester links present.

Preferably, the average chain length of the alkyl or alkenyl group is at least C₁₄, more preferably at least C₁₆. Most preferably at least half of the chains have a length of C₁₈.

It is generally preferred if the alkyl or alkenyl chains are predominantly linear.

The first group of cationic fabric softening compounds for use in the invention is represented by formula (I):

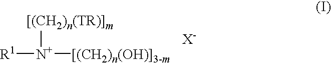

wherein each R is independently selected from a C₅₋₃₅ alkyl or alkenyl group, R¹ represents a C₁₋₄ alkyl, C₂₋₄ alkenyl or a C₁₋₄ hydroxyalkyl group,
T is

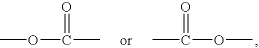

n is 0 or a number selected from 1 to 4, m is 1, 2 or 3 and denotes the number of moieties to which it relates that pend directly from the N atom, and X⁻ is an anionic group, such as halides or alkyl sulphates, e.g. chloride, methyl sulphate or ethyl sulphate.

Especially preferred materials within this formula are di-alkenyl esters of triethanol ammonium methyl sulphate. Commercial examples include Tetranyl AHT-1 (di-hardened oleic ester of triethanol ammonium methyl sulphate 80% active), AT-1 (di-oleic ester of triethanol ammonium methyl sulphate 90% active), L5/90 (palm ester of triethanol ammonium methyl sulphate 90% active), all ex Kao. Other unsaturated quaternary ammonium materials include Rewoquat WE15 (C₁₀-C₂₀ and C₁₆-C₁₈ unsaturated fatty acid reaction products with triethanolamine dimethyl sulphate quaternised 90% active), ex Witco Corporation.

The second group of cationic fabric softening compounds for use in the invention is represented by formula (II):

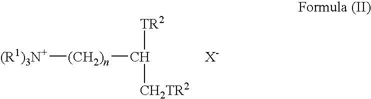

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; n is 0 or an integer from 1 to 5 and T and X⁻ are as defined above.

Preferred materials of this class such as 1,2 bis[tallowoyloxy]-3-trimethylammonium propane chloride and 1,2-bis[oleyloxy]-3-trimethylammonium propane chloride and their method of preparation are, for example, described in U.S. Pat. No. 4,137,180 (Lever Brothers), the contents of which are incorporated herein. Preferably these materials also comprise small amounts of the corresponding monoester, as described in U.S. Pat. No. 4,137,180.

A third group of cationic fabric softening compounds for use in the invention is represented by formula (III):

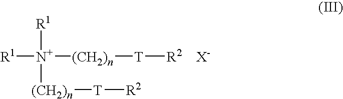

wherein each R¹ group is independently selected from C₁₋₄ alkyl, or C₂₋₄ alkenyl groups; and wherein each R² group is independently selected from C₈₋₂₈ alkyl or alkenyl groups; n is 0 or an integer from 1 to 5 and T and X⁻ are as defined above.

A fourth group of cationic fabric softening compounds for use in the invention is represented by formula (IV):

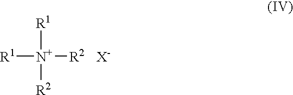

wherein each R¹ group is independently selected from C₁₋₄ alkyl, or C₂₋₄ alkenyl groups; and wherein each R² group is independently selected from C₈₋₂₈ alkyl or alkenyl groups; and X⁻ is as defined above.

The iodine value of the parent fatty acyl compound or acid from which the cationic softening material is formed is from 0 to 140, preferably from 0 to 100, more preferably from 0 to 60.

It is especially preferred that the iodine value of the parent compound is from 0 to 20, e.g. 0 to 4. Where the iodine value is 4 or less, the softening material provides excellent softening results and has improved resistance to oxidation and associated odour problems upon storage.

When unsaturated hydrocarbyl chains are present, it is preferred that the cis:trans weight ratio of the material is 50:50 or more, more preferably 60:40 or more, most preferably 70:30 or more, e.g. 85:15 or more.

The iodine value of the parent fatty acid or acyl compound is measured according to the method set out in respect of parent fatty acids in WO-A1-01/46513.

The softening material is preferably present in an amount of from 2 to 60% by weight of the total composition, more preferably from 2 to 40%, most preferably from 3 to 30% by weight.

The composition optionally comprises a silicone.

### Fluorescent Agent

The composition preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.1 wt %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfoslyryl)biphenyl. Most preferred are disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfoslyryl)biphenyl.

### Perfume

Preferably the composition comprises a perfume. The perfume is preferably in the range from 0.001 to 3 wt %, most preferably 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

All compositions are defined with respect to weight percentage unless otherwise specified.

### EXAMPLES

### Example 1

Various fabrics were separately washed at 20° C., with a liquor to cloth ratio of 30:1 for 30 minutes, in 2 g/L of a base washing powder containing 18% NaLAS surfactant, 73% salts (silicate, sodium tri-poly-phosphate, sulphate, carbonate), 3% minors including fluorescer and enzymes, remainder impurities. Following the wash, clothes were 2 rinsed twice then dried. The experiment was repeated but with the addition of 5 ppm of pigment violet 23. Deposition of the pigment to the cloth was monitored by measuring the % reflectance at 580 nm, R₅₈₀, and comparing to the analogous cloth washed without the pigment.

The results are shown in the table below and expressed as ΔR₅₈₀ where ΔR₅₈₀=R(control)₅₈₀−R(PV23)₅₈₀

| fabric | ΔR₅₈₀ |
|---|---|
| Woven cotton | 2.0 |
| Knitted cotton | 0.9 |
| Woven 65:35 polycotton | 8.0 |
| Knitted 65:35 polycotton | 1.5 |
| Woven Polyester | 0.6 |
| Knitted polyester | 0.3 |
| Woven nylon | 0.1 |
| Knitted nylon | −0.5 |

The pigment shows a strong preference to deposit onto woven polyester cotton (polycotton) fabric.

### Example 2

A mixed load of woven cotton cloth and woven 65:35 polyester:cotton cloth were washed together with a liquor to cloth ratio of 40:1 with 2 g/L of the base washing powder of example 1. The weight ratio of pure cotton to polyester-cotton fabric was 7:5. Cloths used did not contain any fluorescer. The wash took 30 minutes at 20° C. and was followed by two rinses then drying. To the wash was added:

(1) nothing
(2) 100 ppb Direct violet 9

### (3) 2.5 ppm Pigment Violet 23

(4) 100 ppb Direct violet 9+2.5 ppm Pigment Violet 23

After drying the colour of the cloths were measured with a reflectometer and expressed as the CIELAB delta E value relative to the cloths washed without any dye or pigment. The results are given in the table below. Values are the average of 2 experiments.

The higher the delta E value the more shading of the cloth. In (2) the direct violet 9 dye gives a larger shading to the cotton. In (3) the pigment violet 23 give a larger shading to the polycotton. In (4) the combination of dye and pigment gives approximately equal and enhanced shading of both fabrics.

The results are shown in the table below.

| Conditions | Cotton | Polycotton |
|---|---|---|
| (2) | 2.4 | 1.0 |
| (3) | 0.7 | 1.6 |
| (4) | 3.5 | 3.1 |

Direct violet 9 alone give a ΔE of 1.0 on polycotton but in combination with Pigment Violet 23 this rises to 3.1.

### Example 3

A repeatedly worn and washed 65% polyester: 35% cotton white woven shirt (ex Marks and Spencer UK) was obtained from Equest (Newcastle UK). The shirt was cut into portions and washed 5 times in a base washing powder containing 18% NaLAS surfactant, 73% salts (silicate, sodium tri-poly-phosphate, sulphate, carbonate), 3% minors including fluorescer and enzymes, remainder impurities.

Washes were conducted at 20° C., with a liquor to cloth ratio of 30:1 for 30 minutes and followed by 2 rinses.

The experiment was repeated with separate shirt portions with various levels of pigment violet 23 added to the wash liquor. After drying the colour of the cloths were measured with a reflectometer ad expressed as the CIELAB delta E value relative to the shirt portion washed without any pigment violet 23. The results are given in the table below.

A clear dose response and build up with repeat washing is found.

The results are shown in the table below.

| PV23 | First | Second | Third | Fourth | Fifth |
|---|---|---|---|---|---|
| level | Wash | Wash | Wash | Wash | Wash |
| 0.15 ppm | 1.1 | 1.3 | 1.9 | 2.8 | 5.9 |
| 0.6 ppm | 2.4 | 3.2 | 5.1 | 6.5 | 8.8 |
| 1.2 ppm | 5.2 | 7.5 | 9.8 | 11.6 | 15.5 |

### Example 4

Experiment 2 was repeated except the following pigments were added to the wash at a level of 4 ppm
(1) none (control)
(2) Pigment Blue 15:1
(3) Pigment Blue 15:3
(4) Pigment Blue 29

Following drying the reflectance spectra of the clothes were recorded (UV-excluded) and the % reflectance at 570 nm measured.

The results are shown in the table below and expressed as ΔR₅₇₀ where ΔR₅₇₀=R(control)₅₇₀−R(Pigment)₅₇₀

The results are shown in the table below.

| Conditions | Cotton | Polycotton |
|---|---|---|
| (2) | 2.0 | 2.5 |
| (3) | 1.2 | 1.6 |
| (4) | 0.1 | 0.7 |

The organic pigments deposit better than the inorganic. All show better deposition onto the polycotton.

### Example 5

Experiment 2 was repeated using the following dyes and pigments:
(1) none (control)
(2) 2.5 ppm Pigment Violet 23
(3) 0.2 ppm Acid Blue 98
(4) 2.5 ppm Pigment Violet 23+0.2 ppm Acid Blue 98

Following drying the reflectance spectra of the clothes were recorded (UV-excluded) and the % reflectance at 570 nm measured.

The results are shown in the table below and expressed as ΔR₅₇₀ where ΔR₅₇₀=R(control)₅₇₀−R(Pigment/dye)₅₇₀. Larger ΔR₅₇₀ indicates more deposition.

The results are shown in the table below.

| Conditions | Cotton | Polycotton |
|---|---|---|
| (2) | −0.2 | 2.9 |
| (3) | 3.3 | 0.8 |
| (4) | 3.5 | 3.5 |

Acid blue 98 deposits well onto woven cotton, but poorly on woven polycotton. Pigment Violet 23 deposits well onto woven polycotton but poorly onto woven cotton.

The combination of pigment violet 23 and acid blue 98 give good deposition and shading to both fabrics.

Note in the table condition (2) and (3) should be swapped. Acid blue 98 alone gives a ΔR570 of 0.5 on polycotton, when used in combination with Pigment Violet 23 this rises to 3.5.

### Example 6

Various fabrics were separately washed ten times at 20° C., with a liquor to cloth ratio of 25:1 for 30 minutes, in 2 g/L of a base washing powder containing 18% NaLAS surfactant, 73% salts (silicate, sodium tri-poly-phosphate, sulphate, carbonate), 3% minors including fluorescer and enzymes, remainder impurities. Following the wash, clothes were 2 rinsed twice then dried. The experiment was repeated but with the addition of 3 shading system
(a) 0.0004 wt % direct violet 9
(b) 0.003 wt % solvent violet 13
(c) 0.0004 wt % direct violet 9+0.001 wt % solvent violet 13+0.002 wt % pigment violet 23
   to the formulation.

The colour of the cloth was measured using a reflectometer (UV-excluded) and expressed as the CIE LAB values.

The results are shown in the table below and expressed as Δb*=b*(control)−b*(shading), a Δb* greater or equal to 0.3 is taken as significant

| | (a) | (b) | (c) |
|---|---|---|---|
| 50/50 Woven Polycotton | 0.4 | 0.1 | 3.5 |
| 65/35 Woven Polycotton | 0.7 | 0.3 | 1.2 |
| 65/35 Knitted Polycotton | 1.1 | 0.5 | 2.1 |
| Knitted Cotton | 2.6 | 0.1 | 2.8 |
| Cotton towelling | 2.0 | 0.0 | 2.2 |
| Woven Polyester | 0.0 | 0.5 | 0.8 |
| Nylon/Elastane | 0.1 | 0.8 | 2.0 |
| Cotton/Elastane | 1.6 | 0.9 | 2.6 |
| 65/35 Polycotton cut from a Shirt | 0.3 | 0.2 | 1.6 |

For the fabrics shown in bold type addition of pigment violet 23 greatly increases Δb* beyond that which would be expected from the addition of (a) and (b).

### Exemplary Laundry Formulations A, B, C, D

| Formulation | A | B | C | D |
|---|---|---|---|---|
| NaLAS | 15 | 20 | 10 | 12 |
| NI (7EO) | — | — | — | 8 |
| Na tripolyphosphate | 7 | 15 | — | — |
| Soap | — | — | — | 1 |
| Zeolite A24 | — | — | — | 17 |
| Sodium silicate | 5 | 4 | 5 | 1 |
| Sodium carbonate | 23 | 20 | 30 | 20 |
| Sodium sulphate | 40 | 30 | 40 | 20 |
| Carboxymethylcellulose | 0.2 | 0.3 | — | 0.5 |
| Percarbonate | 2 | 3 | — | 10 |
| Taed | 0.5 | 0.8 | — | 4 |
| Protease | 0.005 | 0.01 | — | 0.005 |
| Amylase | 0.001 | 0.003 | — | — |
| Cellulase | — | 0.003 | — | — |
| Fluorescer | 0.1 | 0.15 | 0.05 | 0.3 |
| Pigment Violet 23 | 0.002 | 0.008 | 0.0015 | 0.001 |
| Acid blue 98 | 0.002 | — | 0.002 | |
| Direct Violet 9 | 0.0002 | 0.0008 | — | 0.0004 |
| Direct Violet 99 | — | — | 0.0004 | — |
| Solvent Violet 13 | 0.002 | 0.002 | 0 | 0.001 |
| Sulfonated Zn | 0.002 | 0.004 | — | — |
| Pthalocyanine | | | | |
| photobleach | | | | |
| Water/impurities/ | remainder | remainder | remainder | remainder |
| minors | | | | |

1. A laundry detergent composition comprising:
(a) from 2 to 90% of a surfactant;
(b) from 0.0001 to 0.5% of a blue or a violet organic pigment; and,
(c) at least 0.0001 to 0.05% of one organic dye selected from:
blue or violet direct dyes; blue or violet hydrophobic dyes; blue or violet reactive dye;
blue or violet basic dye; blue or violet dye conjugate; and,
acid dye selected from: (i) azine dyes, wherein the dye is of the following core structure: 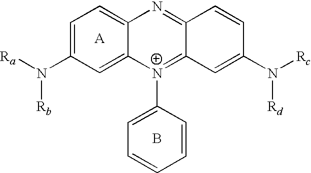
wherein Rₐ, R_{b}, R_{c} and R_{d} are selected from: H, an branched or linear C1 to C7-alkyl chain, benzyl a phenyl, and a naphthyl;
the dye is substituted with at least one SO₃⁻ or —COO⁻ group;
the B ring does not carry a negatively charged group or salt thereof;
and the A ring may further substituted to form a naphthyl;
the dye is optionally substituted by groups selected from: amine, methyl, ethyl, hydroxyl, methoxy, ethoxy, phenoxy, Cl, Br, I, F, and NO₂ and,
(ii) acid violet 17, acid violet 50, acid black 1, acid red 51, acid red 17 and acid blue 29.

2. A laundry detergent composition according to claim 1, wherein the organic pigment is selected from: pigment violet 1, 1:1, 1:2, 2, 3, 5:1, 13, 23, 25, 27, 31, 37, 39, 42, 44, 50 and Pigment blue 1, 2, 9, 10, 14, 18, 19, 24:1, 25, 56, 60, 61, 62, 66, 75, 79 and 80.

3. A laundry detergent composition according to claim 1, wherein the composition comprises a direct dye of the following structure: 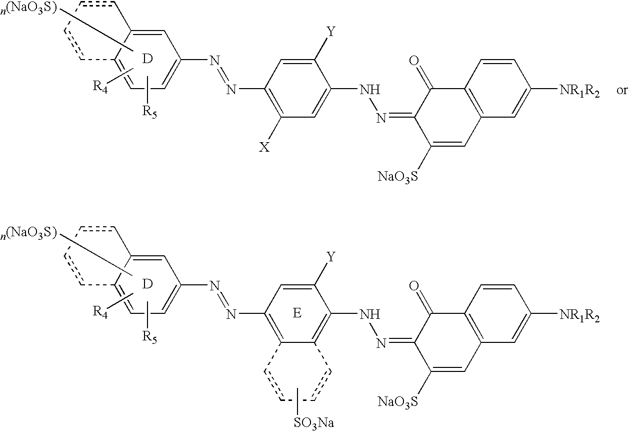
wherein:
ring D and E may be independently naphthyl or phenyl as shown;
R₁ is selected from: hydrogen and C1-C4-alkyl;
R₂ is selected from: hydrogen, C1-C4-alkyl, substituted or unsubstituted phenyl and substituted or unsubstituted naphthyl;
R₃ and R₄ are independently selected from: hydrogen and C1-C4-alkyl;
X and Y are independently selected from: hydrogen, C1-C4-alkyl and C1-C4-alkoxy; and,
n is 0, 1 or 2.

4. A laundry detergent composition according to claim 1, wherein the composition comprises a hydrophobic dye.

5. A laundry detergent composition according to claim 4, wherein the hydrophobic dye is selected from: solvent violet 13, disperse violet 27 disperse violet 26, disperse violet 28, disperse violet 63 and disperse violet 77.

6. A laundry detergent composition according to claim 1, wherein the composition comprises an acid dye.

7. A laundry detergent composition according to claim 1, wherein the composition comprises a direct dye selected from: direct violet 7, direct violet 9, direct violet 11, direct violet 26, direct violet 31, direct violet 35, direct violet 40, direct violet 41, direct violet 51, and direct violet 99.

8. A laundry detergent composition according to claim 1, wherein the composition comprises an organic pigment selected from: pigment violet 3, 13, 23, 27, 37, 39, pigment blue 14, 25, 66 and 75.

9. A laundry detergent composition according claim 8, wherein the organic pigment is pigment violet 23.

10. A laundry detergent composition according to claim 1, wherein the organic pigment has a size in the range from 0.02 to 10 microns.

11. A domestic method of treating a textile, the method comprising the steps of:
(i) treating a textile with an aqueous solution of the laundry detergent composition as defined in claim 1, the aqueous solution comprising from 1 ppb to 5 ppm of the pigment, and from 1 ppb to 1 ppm of at least one other dye selected from: hydrophobic dyes, acid dyes and direct dyes; and, from 0.2 g/L to 3 g/L of a surfactant; and,
(ii) rinsing and drying the textile.

12. A method according to claim 11, wherein a pigment is present in the range from 10 ppb to 200 ppb.

13. A method according to claim 1, wherein a direct dye is present in the range from 2 ppb to 40 ppb.

14. A method according to claim 1, wherein the acid dye is present in the range from 10 ppb to 200 ppb.

15. A method according to claim 1, wherein the hydrophobic dye is present in the range from 10 ppb to 200 ppb.
